(19) United States
(12) Patent Application Publication
(10) Pub. No.: US 2017/0236160 A1
(43) Pub. Date: Aug. 17, 2017

(54) SYSTEM AND METHOD FOR SPECIFYING TARGETED CONTENT FOR CUSTOMERS

(71) Applicant: NETSUITE INC., San Mateo, CA (US)

(72) Inventors: Yukte OBEROI, Santa Clara, CA (US); Mohammad Iman SADREDDIN, Santa Clara, CA (US); Alfredo R. DIMAUNAHAN, Manila (PH)

(21) Appl. No.: 14/694,795

(22) Filed: Apr. 23, 2015

Related U.S. Application Data
(60) Provisional application No. 61/987,368, filed on May 1, 2014.

(51) Int. Cl. G06Q 30/02

(52) U.S. Cl. CPC G06Q 30/0269; G06Q 30/0261

(57) ABSTRACT

Systems, apparatuses, and methods for identifying and delivering content to customers that is intended to encourage purchase of a product or service. In one embodiment, the invention provides two primary processes, operations, or functional elements. The first process enables a retailer/merchant to specify an identifier for an attribute or characteristic of a customer, retailer, device, etc. In some situations, the attribute or characteristic may take on more than one value, with the value depending upon one or more rules or conditions. The retailer may also specify a set of desired content elements and/or associate specific content elements with the identifier (such as by “tagging” specific content elements with the identifier and/or the attribute value). In some cases, the identifier identifies a specific rule set or class of content-related processes, and the content rule or rules define how (i.e., under what conditions) content elements are to be determined, identified, selected, accessed, or presented to a customer.

### CROSS REFERENCE TO RELATED APPLICATION

This application claims the benefit of U.S. Provisional Application No. 61/987,368, entitled “System and Method for Using User-Defined Tags to Specify Content Targeting Rules,” filed May 1, 2014, which is incorporated by reference herein in its entirety (including Appendix) for all purposes.

### BACKGROUND

Retailers (e.g., whether eCommerce or “brick and mortar”) and other types of merchants often wish to provide customers or prospective customers with specific information or content to encourage sale of the retailers' or merchant's products or services. The content may take any suitable form or structure, including images, video, text, documents, messages, links to content, etc., and is typically intended to encourage a customer to purchase a product or service that they have shown an interest in or are expected to be interested in. The interest or expected interest may be a result of the product or service being looked at, browsed, searched for, researched, placed into a “shopping cart”, etc. The overall desire on the part of the retailer or merchant is to increase the likelihood that the customer will convert their expressed or expected interest in a product or service into an actual purchase transaction. As noted, the content may also be used to assist a customer or prospective customer to “discover” a product or service that they were not previously aware of but that the retailer or merchant believes would be of interest (where this “discovery” may be facilitated by providing an advertisement, coupon, review, testimonial, recommendation, etc.).

Identifying content that may be of value to present to a customer or prospective customer may be part of a process of accessing, processing, and evaluating certain types of data relevant to the customer and/or the retailer/merchant. Such data may include, for example, location data, customer demographic/profile data, customer prior shopping or transaction behavior, customer browsing behavior, customer click-through behavior, retailer/merchant inventory or sales data, etc.

Conventional approaches to enabling a retailer or merchant to identify content that they wish to make available to customers typically provide the user with a limited set of attributes that can be used to identify potentially relevant or desired content. While useful, this approach is inherently limited as it does not permit the retailer/merchant user to specify attributes, criteria, conditions, or rules that are more relevant to that user and its business. Further, because a retailer/merchant continues to develop insights into their business and into the behavior of customers over time, the optimal set of useful and desirable attributes or criteria may change over time and therefore is not fully known when the attributes or criteria are initially set. This can cause the factors or methods used to identify content to be presented to a customer or prospective customer to become less relevant to a business or to the customer over time. Embodiments of the invention are directed toward solving these and other problems individually and collectively.

### SUMMARY

The terms “invention,” “the invention,” “this invention” and “the present invention” as used herein are intended to refer broadly to all of the subject matter described in this document and to the claims. Statements containing these terms should be understood not to limit the subject matter described herein or to limit the meaning or scope of the claims. Embodiments of the invention covered by this patent are defined by the claims and not by this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, to any or all drawings, and to each claim.

Embodiments of the invention are directed to systems, apparatuses, and methods for identifying and delivering content to customers that is intended to encourage purchase of a product or service. In one embodiment, the invention provides two primary processes, operations, or functional elements (as illustrated by the set of steps related to definition of data sources, etc. and the separate set of steps related to content access and presentation in FIG. 4). The first process enables a retailer/merchant to specify an identifier for an attribute or characteristic of a customer, retailer, device, etc. In some situations, the attribute or characteristic may take on more than one value, with the value depending upon one or more rules or conditions. The retailer may also specify a set of desired content elements and/or associate specific content elements with the identifier (such as by “tagging” specific content elements with the identifier and/or the attribute value). In some cases, the identifier identifies a specific rule set or class of content-related processes, and the content rule or rules define how (i.e., under what conditions) content elements are to be determined, identified, selected, accessed, or presented to a customer.

As noted, in some embodiments, a “tag” may be used to associate an element of content with the identifier, so that when a specified data location is accessed, content elements with that tag are retrieved for presentation. In some embodiments, the content location, content elements found at a location, or both may be determined by evaluating one or more rules or conditions, with those rules or conditions associated with the tag or identifier.

In some embodiments, the rule or rules may depend on one or more of retailer specific data (e.g., inventory levels, sales levels, revenue, profit margin, rate of change of inventory or another parameter, etc.), customer specific data (e.g., prior purchases, average spend, seasonal spend, browsing behavior, prior or current relationship with retailer, customer social media activity, customer location, other customer activities or hobbies, etc.), customer profile data (e.g., type of device being used, type of network being used, etc.), customer demographic data (e.g., actual or inferred characteristics, such as age, income, education, marital status, number of children, etc.), season, or other potentially relevant data. A rule “evaluation” process may be used to determine the value of the specified attributes or factors; in one embodiment, this is done by reference to data and information located on a multi-tenant data processing platform. Such a platform may contain data corresponding to multiple tenant users and applications related to one or more of Enterprise Resource Planning (ERP), Customer Relationship Management (CRM), eCommerce, Human Resources, or other business-related functions. The evaluation of the specified attributes or factors may be based on real-time values of the data/information, on an average value of the data/information over a specified time period, on a peak value of the data/information, or by other suitable method.

In one embodiment, a rule may be of any suitable logical form, such as “If [certain parameters have specified values], then access content from location X”, but “If parameter A has a value within a range of {a . . . b}, then access content part Y from location X₁”. In one embodiment, a rule may have the form of a “trigger” such that if a certain parameter (or group of parameters) have a value that exceeds a specified threshold, then certain content is accessed and presented (this might be used to offer a customer a special sale price based on inventory levels, the expected availability of a new model, trends in customer spending, etc.). In one embodiment, a rule may depend on a rate of change of one or more parameters; for example, if inventory levels are changing at a certain rate, then one set of content is presented, but if the levels are changing at a different rate, then a different set of content is presented. In one embodiment, a rule may depend on business related parameters (inventory) and real-time values of consumer behavior (browsing, rate of click-through, conversion rate, etc.). In one embodiment, a rule (and hence the content presented and/or its placement when presented) may depend on the characteristics of a customer's device (type, display size, etc.).

A second process to obtain and present the relevant content for a particular customer or use case (which as noted, may include determining that content by evaluating any applicable rules or conditions, accessing the content, and presenting the content in a desired manner) is then executed, typically at a later time. As will be described, this process may be triggered, initiated, or configured by “discovery” of one or more relevant customer, device, network, retailer, or other characteristics. This process locates (and if necessary searches) potentially relevant data and information to identify the content to present to the customer. Typically this involves accessing a network location (such as a specific web-site or web-sites, or a data storage location) containing content that may itself be “tagged” with criteria or an identifier specified by the retailer/merchant. The second process evaluates any applicable rules or conditions and, based on the outcome(s), identifies the relevant content (such as a banner, promotional offer, alert, news item, webpage arrangement, display format, recommendation, query, etc.). The process then retrieves the content and provides the content to the viewer (typically a customer or shopper) in a presentation format that may be determined by the retailer. The result is to present relevant information to a customer or prospective customer, where the relevancy is based on current (and if desired, real-time) values of one or more of business operating characteristics, customer characteristics, device characteristics, and other information specified by a business owner or operator.

In one embodiment, the invention is directed to a multi-tenant data processing system, where the system includes:

one or more business related data processing applications installed in the system and accessible by a plurality of tenants of the multi-tenant data processing system;

a data storage element coupled to the one or more business related data processing applications;

a processor programmed with a set of instructions, wherein when executed by the processor the instructions cause the system to
generate a user interface for a tenant user;
receive a selection of an identifier from the tenant user for a process to select and present content to a customer;
receive a description of a rule or condition from the tenant user, wherein the rule or condition specifies one or more aspects of content to be accessed and presented to the customer upon satisfaction of the rule or condition;
determine a value or values of one or more data associated with the tenant user and/or the customer, wherein the data associated with the tenant user is contained in the data storage element;
evaluate the rule or condition based at least in part on the determined data value or values;
if the rule or condition is satisfied, then initiate a process to access the specified content for presentation to the customer; and
present the accessed element or elements of content to the customer.

In another embodiment, the invention is directed to a method for presenting content to a customer, comprising:

generating a user interface for a user;

receiving a selection of an identifier from the user for a process to select and present content to the customer;

receiving a description of a rule or condition from the user, wherein the rule or condition specifies one or more aspects of content to be accessed and presented to the customer upon satisfaction of the rule or condition;

determining a value or values of one or more data associated with the user and/or the customer, wherein the data associated with the user is related to the user's business operations;

evaluating the rule or condition based at least in part on the determined data value or values;

if the rule or condition is satisfied, then initiating a process to access the specified content for presentation to the customer; and

presenting the accessed element or elements of content to the tenant customer.

Other objects and advantages of the present invention will be apparent to one of ordinary skill in the art upon review of the detailed description of the present invention and the included figures.

### BRIEF DESCRIPTION OF THE DRAWINGS

Embodiments of the invention in accordance with the present disclosure will be described with reference to the drawings, in which:

FIG. 1 is a diagram illustrating a system 100, including an integrated business system 102 and an enterprise network 104 in which an embodiment of the invention may be implemented;

FIG. 2 is a diagram illustrating elements or components of another example operating environment in which an embodiment of the invention may be implemented;

FIG. 3 is a diagram illustrating additional details of the elements or components of the multi-tenant distributed computing service platform of FIG. 2, in which an embodiment of the invention may be implemented;

FIG. 4 is a flow chart or flow diagram illustrating a process, method, operation, or function for specifying/defining desired content and identifying and delivering that content to a customer or shopper, and that may be used when implementing an embodiment of the invention;

FIG. 5 is a diagram illustrating a data schema that may be used when implementing an embodiment of the invention; and

FIG. 6 is a diagram illustrating elements or components that may be present in a computer device or system configured to implement a method, process, function, or operation in accordance with an embodiment of the invention.

Note that the same numbers are used throughout the disclosure and figures to reference like components and features.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the invention will be described more fully hereinafter with reference to the accompanying drawings, which form a part hereof, and which show, by way of illustration, exemplary embodiments by which the invention may be practiced. This invention may, however, be embodied in many different forms and should not be construed as limited to the embodiments set forth herein; rather, these embodiments are provided so that this disclosure will satisfy the statutory requirements and convey the scope of the invention to those skilled in the art.

Among other things, the present invention may be embodied in whole or in part as a system, as one or more methods, or as one or more devices. Embodiments of the invention may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, controller, etc.) that are part of a client device, server, network element, apparatus, or other form of computing or data processing device/platform and that are programmed with a set of executable instructions (e.g., software instructions), where the instructions may be stored in a suitable data storage element. In some embodiments, one or more of the operations, functions, processes, or methods described herein may be implemented by a specialized form of hardware, such as a programmable gate array, application specific integrated circuit (ASIC), or the like. The following detailed description is, therefore, not to be taken in a limiting sense.

Prior to describing one or more exemplary embodiments of the inventive system and methods, it is noted that in the context of the invention, the following terms are to be considered to have at least the indicated meaning(s);
Customer attribute(s): session or transaction based attributes that a business (e.g., a retailer) may use to identify and present information, such as a shopper's viewing/browsing/purchasing behavior, and/or based on values that are known from a customer's record for logging in (e.g., data derived from a “cookie”), network characteristics (wired, wireless, Wi-Fi), etc.
Example: Session based attributes include, but are not limited to, type of device used, geo-location of user, customer demographic data, etc. and/or customer record attributes such as total spent, last purchase date, favorite brand, gender, marital status, inferred income range, etc.
Retailer attribute(s): a characteristic of the retailer that may be used in determining what content to present and/or how to present it. Such characteristics include, but are not limited to: inventory level, profit margin, season, sales in progress or expected, rate of inventory level change, amount of inventory in transit, warehouse location relative to customer, etc.
Tag or Content/Rule Identifier: customer and/or retailer attributes based on which a business desires to target content. Not all customer attributes need be defined as a tag; however a business may use an embodiment of the invention to define almost any customer attribute as a “tag”, and hence make that attribute part of a process to identify, access, retrieve, and present content elements to a customer. Because businesses evolve their operations and goals over time, they typically seek new ways to connect with shoppers and to target their content to the shoppers. The definition of new tags and sets of content/rules permit retailers to modify their content selection and presentation processes to adjust to new technologies, new shopper preferences, new business models, customer behaviors learned over time, etc. Examples of possible tags/identifiers include, but are not limited to those based on: device, most favored brand, total spent, spend rate, seasonal spend, current inventory level, rate of change of inventory level, profit margin, etc.
Note that a “tag” or identifier may have values or other associations, and that use of the tag to identify content may depend on those values or associations satisfying one or more rules, criteria, thresholds, conditions, characteristics, relationships, etc., as specified by a business owner or operator in the form of one or more “rules”.
Tag or identifier value: the value of an attribute specified as a tag. Note that a business will typically target different desired content based on the values of a tag. For example when the tag “device” =mobile, there may be a different content banner as opposed to when the device is not mobile (and hence is presumed to be capable of more effectively displaying a greater amount and variety of content, such as videos, animations, graphics, links, etc.).
Content rule: a rule, criteria, relationship, or condition that determines/defines the content that should be placed in a corresponding content slot/region/area on a webpage corresponding to a specified URL, when content for a specified tag is requested. The content itself may be associated with a location (URL, data storage element on a network, label, etc.), folder, category, event, item, or other form of label or identifier.

As described, embodiments of the present invention are directed to systems, apparatuses, and methods for enabling a retailer to specify or define content that they wish to be presented to a customer/shopper, based on one or more identifiers/tags and/or “rules” that the retailer is able to define. An identifier or tag may be defined in terms of one or more of a customer characteristic (i.e., attribute), a network characteristic, a retailer characteristic, the device being used by the customer, the value of certain ERP, CRM, eCommerce or other data relevant to the retailer, etc.

The retailer may also define one or more content rules (e.g., in the form of conditions, tests, decision processes, etc.) based on an attribute value or values, where the content rule(s) may use any applicable or relevant attribute or data value, condition, relationship, threshold, characteristic, or criteria to specify when and/or which content is to be presented to a customer/shopper. In one embodiment, when a process coupled to a data processing system (such as a multi-tenant data processing platform) determines the value of one or more of the specified/defined attributes or other relevant data, the applicable content rule or rules are evaluated and applied to determine the characteristics of content (such as type, storage location, or placement) that are to be accessed and delivered to the shopper.

In one embodiment, a rule may be of any suitable logical form, such as “If [certain parameters have specified values], then access content from location X”, but “If parameter A has a value within a range of {a. . . b}, then access content part Y from location Xl”. In one embodiment, a rule may have the form of a “trigger” such that if a certain parameter (or group of parameters) have a value that exceeds a specified threshold, then certain content is accessed and presented (this might be used to offer a customer a special sale price based on inventory levels, the expected availability of a new model, trends in customer spending, etc.). In one embodiment, a rule may depend on a rate of change of one or more parameters; for example, if inventory levels are changing at a certain rate, then one set of content is presented, but if the levels are changing at a different rate, then a different set of content is presented. In one embodiment, a rule may depend on business related parameters (inventory) and real-time values of consumer behavior (browsing, rate of click-through, conversion rate, etc.).

In general, a rule may depend on or be a function of one or more of customer specific attributes/data (customer type, device type, customer purchase history, customer browsing history, customer actual or inferred demographic data, etc.), retailer specific attributes/data (inventory level, profit margin, rate of change of inventory level, location of warehouse, location of store, etc.), and other relevant data (season, relationship to upcoming event, etc.). The flexibility in defining the data to be presented, the conditions under which to present it, and the placement of the data (such as the delivery format and arrangement) provided by an embodiment of the inventive system and methods permits a retailer to deliver targeted content to a customer based on multiple and in some cases dynamic parameters. This enables the delivered content to be more relevant to the customer and more closely aligned with the retailer's business operations.

In one embodiment, a process may search for and identify the content that satisfies a content rule or rules (which may involve consideration of attribute or data values, thresholds, criteria, rules, conditions, comparisons, relationships, rates of change, etc. among one or more sources of data resident on a data processing platform). The content satisfying the applicable content rule or rules is returned to a process which presents the content to the shopper. As noted, the presented content and/or its format may depend on one or more of the shopper's browsing behavior, the shopper's previous purchase behavior, the shopper's demographics, the device or data connection being used by the shopper, the location of the shopper, the shopper's profile with the retailer, the retailer's current ERP, CRM, eCommerce or other operational data (such as inventory level, sales, revenue, profit margin, etc.), the retailer's local promotions or events, etc.

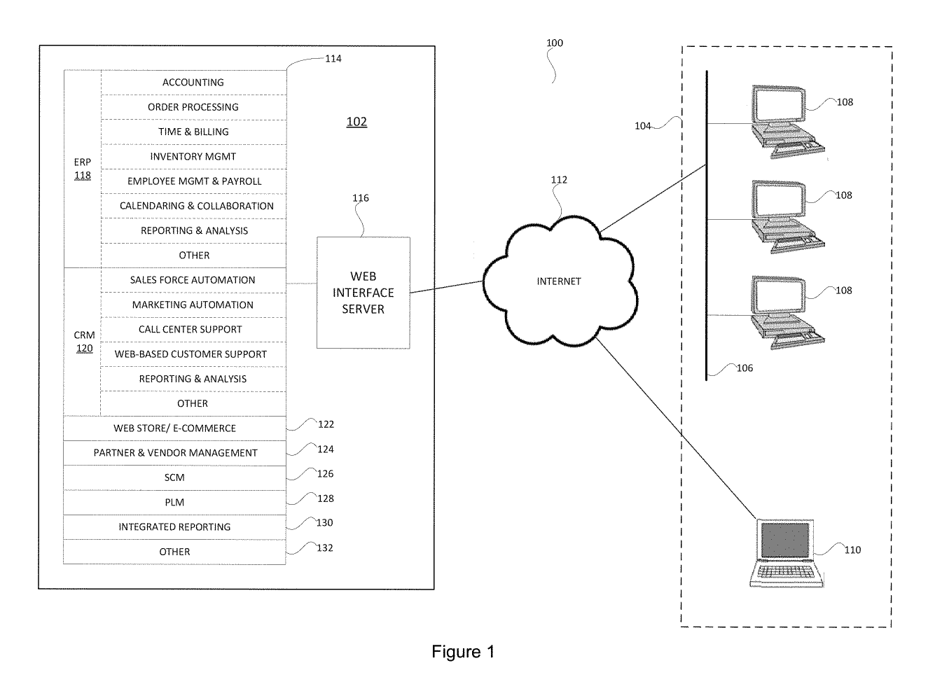

As noted, in some embodiments, the invention may be implemented in the context of a multi-tenant, “cloud” based environment (such as a multi-tenant business data processing platform), typically used to develop and provide web services and business applications for end users. This exemplary implementation environment will be described with reference to FIGS. 1, 2, and 3. Note that embodiments of the invention may also be implemented in the context of other computing or operational environments or systems, such as for an individual business data processing system, a private network used with a plurality of client terminals, a remote or on-site data processing system, another form of client-server architecture, etc.

Modern computer networks incorporate layers of virtualization so that physically remote computers and computer components can be allocated to a particular task and then reallocated when the task is done. Users sometimes speak in terms of computing “clouds” because of the way groups of computers and computing components can form and split responsive to user demand, and because users often never see the computing hardware that ultimately provides the computing services. More recently, different types of computing clouds and cloud services have begun emerging.

For the purposes of this description, cloud services may be divided broadly into “low level” services and “high level” services. Low level cloud services (sometimes called “raw” or “commodity” services) typically provide little more than virtual versions of a newly purchased physical computer system: virtual disk storage space, virtual processing power, an operating system, and perhaps a database such as an RDBMS. In contrast, high or higher level cloud services typically focus on one or more well-defined end user applications, such as business oriented applications. Some high level cloud services provide an ability to customize and/or extend the functionality of one or more of the end user applications they provide; however, high level cloud services typically do not provide direct access to low level computing functions.

The ability of business users to access crucial business information has been greatly enhanced by the proliferation of IP-based networking together with advances in object oriented Web-based programming and browser technology. Using these advances, systems have been developed that permit web-based access to business information systems, thereby allowing a user with a browser and an Internet or intranet connection to view, enter, or modify business information. For example, substantial efforts have been directed to Enterprise Resource Planning (ERP) systems that integrate the capabilities of several historically separate business computing systems into a common system, with a view toward streamlining business processes and increasing efficiencies on a business-wide level. By way of example, the capabilities or modules of an ERP system may include (but are not required to include, nor limited to only including): accounting, order processing, time and billing, inventory management, retail point of sale (POS) systems, eCommerce, product information management (PIM), demand/material requirements planning (MRP), purchasing, content management systems (CMS), professional services automation (PSA), employee management/payroll, human resources management, and employee calendaring and collaboration, as well as reporting and analysis capabilities relating to these functions.

In a related development, substantial efforts have also been directed to integrated Customer Relationship Management (CRM) systems, with a view toward obtaining a better understanding of customers, enhancing service to existing customers, and acquiring new and profitable customers. By way of example, the capabilities or modules of a CRM system can include (but are not required to include, nor limited to only including): sales force automation (SFA), marketing automation, contact list, call center support, returns management authorization (RMA), loyalty program support, and web-based customer support, as well as reporting and analysis capabilities relating to these functions. With differing levels of overlap with ERP/CRM initiatives and with each other, efforts have also been directed toward development of increasingly integrated partner and vendor management systems, as well as web store/eCommerce, product lifecycle management (PLM), and supply chain management (SCM) functionality.

FIG. 1 is a diagram illustrating a system 100, including an integrated business system 102 and an enterprise network 104 in which an embodiment of the invention may be implemented. Enterprise network 104 may be associated with a business enterprise, such as a merchant. Alternatively, and in accordance with the advantages of an application service provider (ASP) hosted integrated business system, the business enterprise may comprise fewer or no dedicated facilities or business network at all, provided that its end users have access to an internet browser and an internet connection. For simplicity and clarity of explanation, the enterprise network 104 is represented by an on-site local area network 106 to which a plurality of personal computers 108 are connected, each generally dedicated to a particular end user (although such dedication is not required), along with an exemplary remote user computer 110 that can be, for example, a laptop computer or tablet computer of a traveling employee having internet access through a hotel, coffee shop, a public Wi-Fi access point, or other internet access modality. The end users associated with computers 108 and 110 may also (or instead) possess an internet-enabled smartphone or other electronic device (such as a PDA) having wireless internet access or other synchronization capabilities. Users of the enterprise network 104 interface with the integrated business system 102 across the Internet 112 or another suitable communications network or networks.

Integrated business system 102, which may be hosted by a dedicated third party ASP, may include an integrated business server 114 and a web interface server 116, coupled as shown in FIG. 1. It is to be appreciated that either or both of the integrated business server 114 and the web interface server 116 may be implemented on one or more different hardware systems and components even though represented as singular units in FIG. 1. Integrated business server 114 comprises an ERP module 118 and further comprises a CRM module 120. In many cases, it will be desirable for the ERP module 118 to share methods, libraries, databases, subroutines, variables, etc., with CRM module 120, and indeed ERP module 118 may be intertwined with CRM module 120 into an integrated Business Data Processing Platform (which may be single tenant, but is typically multi-tenant).

The ERP module 118 may include, but is not limited to, a finance and accounting module, an order processing module, a time and billing module, an inventory management and distribution module, an employee management and payroll module, a calendaring and collaboration module, a reporting and analysis module, and other ERP-related modules. The CRM module 120 may include, but is not limited to, a sales force automation (SFA) module, a marketing automation module, a contact list module (not shown), a call center support module, a web-based customer support module, a reporting and analysis module, and other CRM-related modules. The integrated business server 114 (or multi-tenant data processing platform) further may provide other business functionalities including a web store/eCommerce module 122, a partner and vendor management module 124, and an integrated reporting module 130. An SCM (supply chain management) module 126 and PLM (product lifecycle management) module 130 may also be provided. Web interface server 116 is configured and adapted to interface with the integrated business server 114 to provide one or more web-based user interfaces to end users of the enterprise network 104.

The integrated business system shown in FIG. 1 may be hosted on a distributed computing system made up of at least one, but likely multiple, “servers.” A server is a physical computer dedicated to run one or more software services intended to serve the needs of the users of other computers in data communication with the server, for instance via a public network such as the Internet or a private “intranet” network. The server, and the services it provides, may be referred to as the “host” and the remote computers, and the software applications running on the remote computers, being served as “clients.” Depending on the computing service that a server offers it could be referred to as a database server, file server, mail server, print server, web server, etc. A web server is a most often a combination of hardware and the software that helps deliver content, commonly by hosting a website, to client web browsers that access the web server via the Internet.

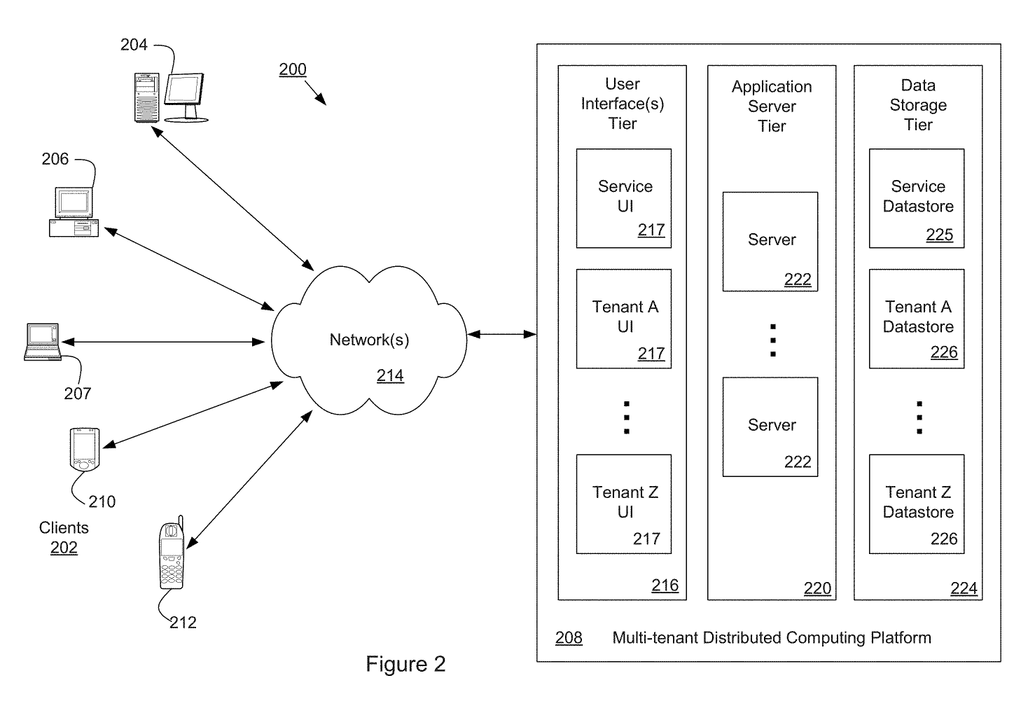

FIG. 2 is a diagram illustrating elements or components of another example operating environment 200 in which an embodiment of the invention may be implemented. As shown, a variety of clients 202 incorporating and/or incorporated into a variety of computing devices may communicate with a distributed computing service/platform 208 through one or more networks 214. For example, a client may incorporate and/or be incorporated into a client application (e.g., software) implemented at least in part by one or more of the computing devices. Examples of suitable computing devices include personal computers, server computers 204, desktop computers 206, laptop computers 207, notebook computers, tablet computers or personal digital assistants (PDAs) 210, smart phones 212, cell phones, and consumer electronic devices incorporating one or more computing device components, such as one or more electronic processors, microprocessors, central processing units (CPU), or controllers. Examples of suitable networks 214 include networks utilizing wired and/or wireless communication technologies and networks operating in accordance with any suitable networking and/or communication protocol (e.g., the Internet).

The distributed computing service/platform (which may also be referred to as a multi-tenant business data processing platform) 208 may include multiple processing tiers, including a user interface tier 216, an application server tier 220, and a data storage tier 224. The user interface tier 216 may maintain multiple user interfaces 217, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs). The default user interface may include components enabling a tenant to administer the tenant's participation in the functions and capabilities provided by the service platform, such as accessing data, causing the execution of specific data processing operations, etc. Each processing tier shown in the figure may be implemented with a set of computers and/or computer components including computer servers and processors, and may perform various functions, methods, processes, or operations as determined by the execution of a software application or set of instructions. The data storage tier 224 may include one or more data stores, which may include a Service Data store 225 and one or more Tenant Data stores 226.

Each tenant data store 226 may contain tenant-specific data that is used as part of providing a range of tenant-specific business services or functions, including but not limited to ERP, CRM, eCommerce, Human Resources management, payroll, etc. Data stores may be implemented with any suitable data storage technology, including structured query language (SQL) based relational database management systems (RDBMS).

In accordance with one embodiment of the invention, distributed computing service/platform 208 may be multi-tenant and service platform 208 may be operated by an entity in order to provide multiple tenants with a set of business related applications, data storage, and functionality. These applications and functionality may include ones that a business uses to manage various aspects of its operations. For example, the applications and functionality may include providing web-based access to business information systems, thereby allowing a user with a browser and an Internet or intranet connection to view, enter, process, or modify certain types of business information.

As noted, such business information systems may include an Enterprise Resource Planning (ERP) system that integrates the capabilities of several historically separate business computing systems into a common system, with the intention of streamlining business processes and increasing efficiencies on a business-wide level. By way of example, the capabilities or modules of an ERP system may include: accounting, order processing, time and billing, inventory management, employee management/payroll, and employee calendaring and collaboration, as well as reporting and analysis capabilities relating to these functions. Another business information system that may be provided as part of an integrated service platform is an integrated Customer Relationship Management (CRM) system, which is designed to assist in obtaining a better understanding of customers, enhance service to existing customers, and assist in acquiring new and profitable customers. By way of example, the capabilities or modules of a CRM system may include: sales force automation (SFA), marketing automation, contact list management, call center support, and web-based customer support, as well as reporting and analysis capabilities relating to these functions. In addition to ERP and CRM functions, a business information system/platform (such as element 208 of FIG. 2) may also include one or more of an integrated partner and vendor management system, eCommerce system (e.g., a virtual storefront application or platform), product lifecycle management (PLM) system, Human Resources management system (which may include medical/dental insurance administration, payroll, etc.), or supply chain management (SCM) system.

Note that both functional advantages and strategic advantages may be gained through the use of an integrated business system comprising ERP, CRM, and other business capabilities, as for example where the integrated business system is integrated with a merchant's eCommerce platform and/or “web-store.” For example, a customer searching for a particular product can be directed to a merchant's website and presented with a wide array of product and/or services from the comfort of their home computer, or even from their mobile phone. When a customer initiates an online sales transaction via a browser-based interface, the integrated business system can process the order, update accounts receivable, update inventory databases and other ERP-based systems, and can also automatically update strategic customer information databases and other CRM-based systems. These modules and other applications and functionalities may advantageously be integrated and executed by a single code base accessing one or more integrated databases as necessary, forming an integrated business management system or platform.

As will be described in greater detail, this ability to store, access, and process a variety of business related data within one platform or “suite” of applications enables embodiments of the invention to provide users with greater flexibility in defining the parameters of a customized content delivery process for customers. For example, embodiments include methods of content selection and delivery that may depend at least in part on real-time or pseudo real-time values of business data (e.g., revenue, sales levels, inventory levels, operating costs) and/or customer characteristics (e.g., type of device, location, location relative to a store, current spend, expected spend, etc.).

The integrated business system shown in FIG. 2 may be hosted on a distributed computing system made up of at least one, but typically multiple, “servers.” A server is a physical computer dedicated to run one or more software services intended to serve the needs of the users of other computers in data communication with the server, for instance via a public network such as the Internet or a private “intranet” network. The server, and the services it provides, may be referred to as the “host” and the remote computers and the software applications running on the remote computers may be referred to as the “clients.” Depending on the computing service that a server offers it could be referred to as a database server, file server, mail server, print server, web server, etc. A web server is a most often a combination of hardware and the software that helps deliver content (typically by hosting a website) to client web browsers that access the web server via the Internet.

Rather than build and maintain such an integrated business system themselves, a business may utilize systems provided by a third party. Such a third party may implement an integrated business system/platform as described above in the context of a multi-tenant platform, wherein individual instantiations of a single comprehensive integrated business system are provided to a variety of tenants. One advantage to such multi-tenant platforms is the ability for each tenant to customize their instantiation of the integrated business system to that tenant's specific business needs or operational methods. Each tenant may be a business or entity that uses the multi-tenant platform to provide business data and/or functionality to multiple users (such as employees and customers). Some of those multiple users may have distinct roles or responsibilities within the business or entity. In some embodiments, the invention provides a method for enabling a user (such as a retailer) to define/specify content that is to be delivered to a shopper who is visiting the user's eCommerce website. This may provide a more effective way to encourage a shopper to make a purchase, enroll in a warranty or loyalty program, participate in a local event, view content that is formatted for the customer's device, etc.

In some cases, a tenant may desire to modify or supplement the functionality of an existing platform application by introducing an extension to that application, where the extension is to be made available to the tenant's employees and/or customers. In some cases such an extension may be applied to the processing of the tenant's business related data that is resident on the platform. The extension may be developed by the tenant or by a 3^{rd} party developer and then made available to the tenant for installation. The platform may include a “library” or catalog of available extensions, which can be accessed by a tenant and searched to identify an extension of interest. Software developers may be permitted to “publish” an extension to the library or catalog after appropriate validation of a proposed extension.

Thus, in an effort to permit tenants to obtain the services and functionality that they desire (which may include providing certain services to their end customers, such as functionality associated with an eCommerce platform), a multi-tenant service platform may permit a tenant to configure certain aspects of the available service(s) to better suit their business needs. In this way aspects of the service platform may be customizable, and thereby enable a tenant to configure aspects of the platform to provide distinctive services to their respective users or to groups of those users. For example, a business enterprise that uses the service platform may want to provide additional functions or capabilities to their employees and/or customers, or to cause their business data to be processed in a specific way in accordance with a defined workflow that is tailored to their business needs, etc.

Tenant customizations to the platform may include custom functionality (such as the capability to perform tenant or user-specific functions, data processing, or operations) built on top of lower level operating system functions. Some multi-tenant service platforms may offer the ability to customize functions or operations at a number of different levels of the service platform, from aesthetic modifications to a graphical user interface to providing integration of components and/or entire applications developed by independent third party vendors. This can be very beneficial, since by permitting use of components and/or applications developed by third party vendors, a multi-tenant service can significantly enhance the functionality available to tenants and increase tenant satisfaction with the platform. As one example, some or all of the functionality of the inventive processes or methods may be executed by an extension that is made available to one or more tenants.

As noted, in addition to user customizations, an independent software developer may create an extension to a particular application that is available to users through a multi-tenant data processing platform. The extension may add new functionality or capabilities to the underlying application. One or more tenants/users of the platform may wish to add the extension to the underlying application in order to be able to utilize the enhancements to the application that are made possible by the extension. Further, the developer may wish to upgrade or provide a patch to the extension as they recognize a need for fixes or additional functionality that would be beneficial to incorporate into the extension. In some cases the developer may prefer to make the upgrade available to only a select set of users (at least initially) in order to obtain feedback for improving the newer version of the extension, to test the stability of the extension, or to assist them to segment the market for their extension(s).

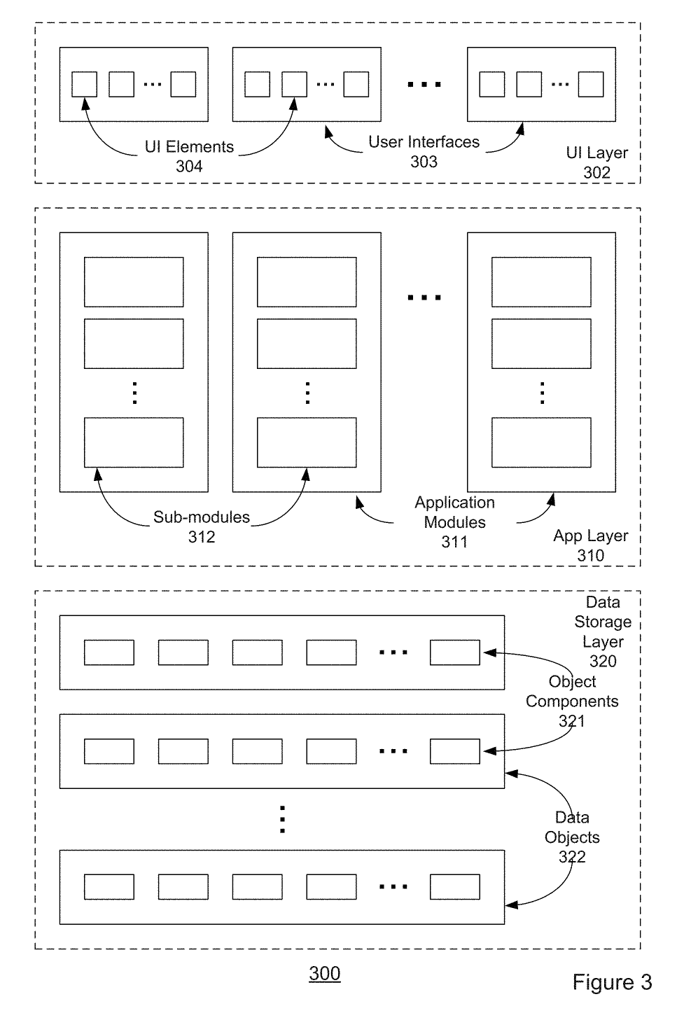

FIG. 3 is a diagram illustrating additional details of the elements or components of the multi-tenant distributed computing service platform of FIG. 2, in which an embodiment of the invention may be implemented. The software architecture depicted in FIG. 3 represents an example of a complex software system to which an embodiment of the invention may be applied. In general, an embodiment of the invention may be implemented using a set of software instructions that are designed to be executed by a suitably programmed processing element (such as a CPU, microprocessor, processor, controller, computing device, etc.). In a complex system such instructions are typically arranged into “modules” with each such module performing a specific task, process, function, or operation. The entire set of modules may be controlled or coordinated in their operation by an operating system (OS) or other form of organizational platform.

As noted, FIG. 3 is a diagram illustrating additional details of the elements or components 300 of the multi-tenant distributed computing service platform of FIG. 2, in which an embodiment of the invention may be implemented. The example architecture includes a user interface layer or tier 302 having one or more user interfaces 303. Examples of such user interfaces include graphical user interfaces and application programming interfaces (APIs). Each user interface may include one or more interface elements 304. For example, users may interact with interface elements in order to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks and dialog boxes. Application programming interfaces may be local or remote, and may include interface elements such as parameterized procedure calls, programmatic objects and messaging protocols.

The application layer 310 may include one or more application modules 311, each having one or more sub-modules 312. Each application module 311 or sub-module 312 may correspond to a particular function, method, process, or operation that is implemented by the module or sub-module. Such function, method, process, or operation may include those used to implement one or more aspects of an ERP, CRM, eCommerce, or other business related data processing operation. Such function, method, process, or operation may also include those used to implement one or more aspects of the inventive system and methods, such as for:
Providing a user interface to enable a retailer/tenant or other user to specify or define one or more attributes or characteristics (such as specific information, data, categories, etc.) to be used to identify content to be delivered to a customer/shopper;
Enabling the retailer/tenant or other user to define one or more content rules or conditions that specify attribute or data values, criteria, characteristics, conditions, thresholds, or other relationships, where the content rule(s) are evaluated to identify if content is to be accessed and delivered to the customer/shopper and what that content is (based for example, on a specified value of the attribute);
At a later time, determining a value of the specified or defined attribute, attributes, or data, typically by reference to information about one or more of the customer/shopper, the customer/shopper's device, the customer/shopper's location, the retailer's business operations (such as inventory, profit margin, sales level), etc.;
Based on evaluating the one or more attributes or data and any applicable rules or conditions, determining if content (and if so, what content) is to be presented to a customer;
Executing a process to locate and/or access content that is associated with the attribute or data value, and/or that satisfies the one or more applicable rules or conditions (such as by retrieving content from a specified location, executing a search, etc.); and
Delivering the located or accessed content to the customer/shopper (and if desired, presenting the content in a specified format or arrangement that may depend on the day, season, time of day, user device, etc.).

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 222 of FIG. 2) may include each application module. Alternatively, different application servers may include different sets of application modules. Such sets may be disjoint or overlapping.

The data storage layer 320 may include one or more data objects 322 each having one or more data object components 321, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

Note that the example computing environments depicted in FIGS. 1-3 are not intended to be limiting examples. Alternatively, or in addition, computing environments in which an embodiment of the invention may be implemented include any suitable system that permits users to provide data to, and access, process, and utilize data stored in a data storage element (e.g., a database) that can be accessed remotely over a network. Further example environments in which an embodiment of the invention may be implemented include devices (including mobile devices), software applications, systems, apparatuses, networks, product recommendation methods, eCommerce or advertising platforms, or other configurable components that may be used by multiple users for data entry, data processing, application execution, data review, etc. Although further examples below may reference the example computing environment depicted in FIGS. 1-3, it will be apparent to one of skill in the art that the examples may be adapted for alternate computing devices, systems, apparatuses, processes, and environments.

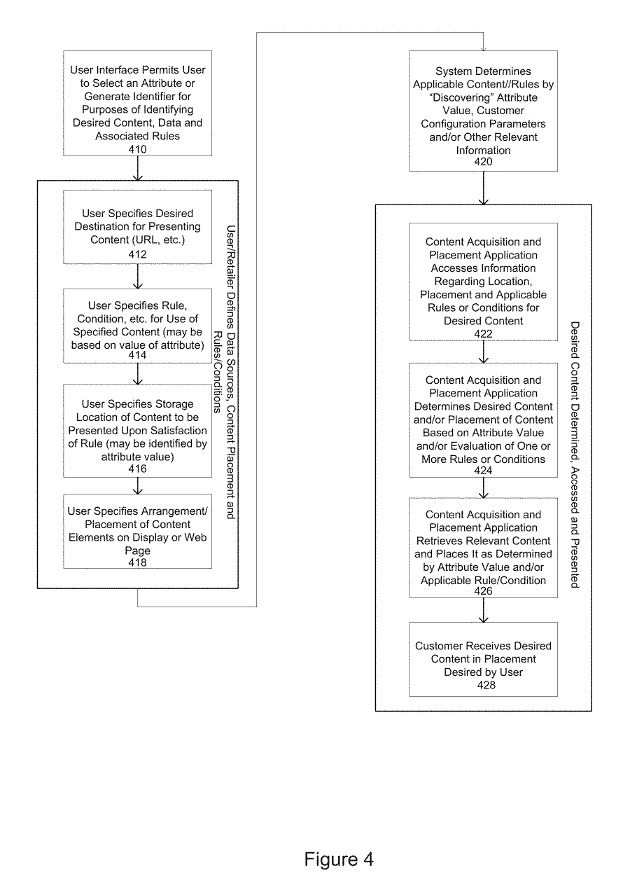

FIG. 4 is a flow chart or flow diagram illustrating a process, method, operation, or function for specifying/defining desired content and identifying and delivering that content to a customer or shopper, and that may be used when implementing an embodiment of the invention. As shown in the figure, in some embodiments, the invention provides two primary processes, operations, or functional elements (as illustrated by the set of steps related to definition of data sources, etc. and the separate set of steps related to content access and presentation in FIG. 4).

In general terms, the processes illustrated in FIG. 4 enables a user to define an identifier and a set of applicable rules or criteria that determine what content elements to present to a customer, and how to present them. The content elements may be banners, advertisements, images, text, links, etc., and may be associated with a “tag” or other form of identifier. The “tag” or identifier for the content may be used to associate that content element with a use case (such as for a particular type of customer device, season, customer demographic, etc.). The tag or identifier may also or instead be used to define the placement or arrangement of a content element (e.g., by reference to a template or webpage definition). A content or content element “rule” may be defined by a user and evaluated in order to determine which content elements to access and present to a customer. Such a rule may depend on one or more of a customer attribute value, a retailer attribute value, a device type, a network characteristic, a season, an event, a location, or other relevant parameter. In some cases, one or more parameters of a rule may have a value determined by data stored and processed by a multi-tenant platform (such as inventory level data, sales data, revenue data, changes in inventory, profit margin, store location, inventory in transit, events planned by stores, etc.).

FIG. 4 illustrates a data processing method, process, operation, or function that enables a user to specify an attribute of interest, and then to define the conditions under which certain content elements are to be accessed and presented to a customer. In the example of FIG. 4, the attribute of interest may be capable of assuming more than one value, and one or more of (a) the storage or access location of the desired content elements, (b) the specific content elements to be used, and (c) the placement of the specific elements when presented to a viewer may depend upon the attribute value. The example of FIG. 4 may be used in a situation in which content elements are previously associated with an attribute value, so that when the attribute has that value, the applicable content elements are readily identified. In contrast, one or more of the variations of the data processing method, process, operation, or function illustrated in FIG. 4 described herein may provide a user with a more flexible form of identifying desired content elements and may incorporate more complex “rules” or conditions.

In the exemplary embodiment shown in FIG. 4, a user (such as a retailer or tenant of a multi-tenant data processing platform) is presented with a user interface to permit the user to select an attribute to be used as the basis for selecting content elements to present to a customer (step or stage 410). This attribute may be a customer attribute (e.g., gender, age range, income range, zip code, purchase history, browsing history, etc.), a retailer attribute (e.g., inventory level, profit margin, revenue, rate of change of inventory, warehouse location, store location, etc.), a customer device attribute (e.g., desktop, laptop, mobile, etc.), an external attribute (e.g., season, month, expected weather, etc.), etc. The selected attribute is typically information or data that is stored or determined by other elements of a data processing system that is executing the exemplary embodiment (or is in communication with/coupled to a data processing element that is executing the exemplary embodiment). The selected attribute may have one or more values, with the value typically being used to determine the content to be presented to a customer (and in some cases, how that content will be presented).

The value of the selected attribute may be used by the retailer to determine the content elements presented to a customer for purposes of advertising, encouraging a purchase, providing information, requesting an opinion or comments, or other types of campaigns or interactions. Typically, the content elements will be presented to the customer in the form of a webpage (directly or via a provided link/URL), although the content elements may also be presented in other forms, including but not limited to, email, an image, a video, etc.

In the next set of steps or stages (identified as “User/Retailer Defines Data Sources, Content Placement and Rules/Conditions” in the figure, and which may occur in an order or sequence different than that illustrated), the retailer may specify or select a desired destination for presenting the determined content elements (typically in the form of a URL or other location address, as in step or stage 412). In some embodiments, this may represent a webpage which the customer will be provided for viewing after it is constructed from the determined content elements (which may include a banner, text, images, video, etc.). The retailer may also specify a rule or condition which partially or wholly determines when certain content elements are to be used for presentation to a customer (as in step or stage 414).

In one embodiment, this rule or condition may take the form of “If attribute value=X, then content to be presented is Y” (where “Y” may describe something about the desired content elements, such as an identifier or common characteristic), or “If attribute value=X, then content to be presented is located at Z” (as suggested by step or stage 416). For example, if the attribute is a device type, then if the device type equals “mobile”, a rule may direct the process to access content elements located in a specific directory, network location, folder, etc. Such a directory, network location, or folder may contain a group of content elements (banners, display advertisements, coupons, images, etc.) that the retailer wishes to present to a customer using a mobile device. In one embodiment, the location may contain content elements that are themselves tagged or otherwise identified by the attribute value so that the process can select them from among a larger group of elements.

The retailer may also specify or select a desired arrangement or presentation of the content elements (as suggested by step or stage 418). This may involve specifying a template or form of layout into which the content elements are to be inserted. It may also or instead involve specifying a name or location of a directory, network location, or folder that contains a definition or description of a webpage or other form of display that will be constructed using the content elements. The information, data, rules, etc. provided by the retailer are then saved and stored for later access and execution.

At a later time (typically when a customer navigates to a URL (such as a retailer's home page or a page of a catalog) or submits a query), one or more attribute values may be discovered or determined by a process or system element (as suggested by step or stage 420). For example, by processing a customer's search query, it may be possible to identify certain information about the customer's device, the network being used by the customer, the customer's general location, etc. In some embodiments, an application or process that is executed by a point of sale terminal (POS), eCommerce application installed on a customer's device, or a retailer's web-site may derive, access, or otherwise obtain data that represents an attribute value. This discovered information, either alone or in combination with other information known to the system (such as season, date, events promoted by the retailer, etc.) may then be used to determine one or more attribute values. These attribute values may then be used to determine the location and presentation of a set of desired content elements (as suggested by the steps or stages identified as “Desired Content Determined, Accessed and Presented” in the figure, and which may occur in an order or sequence different than that illustrated).

Based on the discovered or determined value for one or more attributes, a Content Acquisition and Placement application or process may then use that information to access information regarding the location, placement, and applicable rules or conditions for that attribute and value, or attributes and values (step or stage 422). This may involve using the attribute/value to determine a directory, URL, folder, etc. which contains a set of content elements and/or applicable rules or conditions. A rule or condition may then be evaluated to determine the specific content elements to utilize from that location (e.g., “If attribute value=X, then present content element set 1”, or “If attribute value=Y, then present content element set 2”, etc.), as suggested by step or stage 424 of FIG. 4.

Next, the process accesses the appropriate set of content elements and generates the desired presentation of those elements, as suggested by step or stage 426. Note that the identification of the appropriate content elements and their presentation may be determined by a rule or condition that takes into account the value of one or more attributes. For example, the presentation may depend on a “tag” or identifier associated with a content element, or a template, style sheet, or webpage definition associated with a specific attribute or attribute value, etc. For instance, if the attributes of interest are “season” and “device type”, then a rule may cause the process to access a specific folder and presentation template when “season =fall” and “device type =mobile”, but a different folder and presentation template when “season =fall” and “device type =laptop”, etc. Further, the presentation template may define spaces or locations on a webpage for various content elements based on a “tag” or identifier associated with an element or some other way of determining where a specific element or type of element should be placed for presentation to a customer. After evaluating any applicable rules or conditions, accessing the appropriate content elements, and generating the appropriate presentation of the content elements, the elements are presented to the customer in the form of a webpage, form, image, document, etc. (as suggested by step or stage 428 of the figure).

Note that the embodiment incorporating the process, method, function, or operation described with reference to FIG. 4 includes the following steps or sub-processes:
User selection of an attribute that will be used as the basis for selecting desired content;
User definition of a rule or condition that determines a set of content elements and/or an element presentation based on the value of the attribute selected; and
System operates to discover/determine attribute value in order to identify, access, and present the appropriate content elements.

In another embodiment, these steps or sub-processes may be extended/expanded to include a more complex and data-dependent implementation of these or other aspects of the inventive systems and processes. For example:
The user may create/select an identifier for a desired set of content elements, with that identifier being used to access one or more rules or conditions that may be a function of more than one attribute (where data that determines a value for that attribute or attributes may be stored in a database or data storage element of a business data processing platform). For example the content elements desired for presentation to a customer may be based on the customer's device type and spend amount during the previous three months, so that the identifier is “customer type 1”, which results in the process evaluating a rule involving both a “device type” attribute and a “customer prior spend” attribute;
The user may define one or more rules or conditions, where evaluation of the rules or conditions determine a set of content elements and/or element presentation based on the value of multiple attributes or data types. For example, a rule may take the form of “If ‘device type=mobile’ and ‘location=within 5 miles of store’, then desired content is group 2” or “If ‘device type=mobile’ and ‘location=within 5 miles of store’ and ‘inventory level rate of change =X’, then desired content is group 3”, where the attribute “inventory level rate of change” may refer to the result of accessing and/or processing data related to the business operations of the retailer (such as ERP, CRM, financial, eCommerce or other data stored and processed on a multi-tenant business data processing platform); and
The system may “discover” or determine one or more attribute values used to identify and present the desired content elements by reference to real-time or pseudo real-time values of data stored and processed for the retailer's business on a multi-tenant business data processing platform (such as ERP, CRM, financial, or eCommerce related data), by reference to information regarding a customer's device or type of network being used for access (such as Wi-Fi, wireless, etc.), or by reference to other relevant information or data (such as customer location, location relative to a store or warehouse, time of day, season, etc.).

As examples of an identifier that may be used in implementing an embodiment of the invention, the following represent possible use cases where a different set of content might be presented to a customer:
Device: mobile;
Device: laptop;
Season: summer;
Location: in-store;
Event: New Year's sale
Event: local store promotion
Spend Category: level 2, etc.

In general, the identifier is a short-hand label or code for a set of content that the retailer or user desires to have delivered to a customer based on a specific characteristic of the customer (such as type of device, location relative to a store, typical spending habits, etc.) or another relevant factor (such as season, time of day, etc.). Note that in some embodiments, the label or identifier itself might be determined as the result of evaluating one or more attribute values, such as an attribute based on the season, month, time of day, etc.

As described, once the user has created an identifier (or selected an existing one for purposes of editing), a set of steps related to definition of data sources, the determination of desired content, and the placement of that content are executed. As described with reference to step or stage 412, the user is requested to specify the desired location or destination for the selected content. In one example, this might be a URL such as “www.business.mobile”, a network data storage location from which the desired content will be accessed in generating a webpage to serve to a customer, etc. Next, the user may be requested to specify or define one or more rules, conditions, threshold values, or other forms of determining whether certain content should be provided to the customer (as described with reference to step or stage 414 of FIG. 4).

As described herein, a retailer may define one or more content rules (e.g., in the form of relationships, conditions, tests, decision processes, etc.) to be applied to determine which content elements (e.g., banners, advertisements, text, images, etc.) to present to a customer. In one embodiment, the content rule(s) may use any applicable or relevant data value, condition, relationship, threshold, characteristic, or criteria to determine when and/or which content is to be presented. In one embodiment, when a process or application coupled to a data processing system (such as a multi-tenant data processing platform) determines the value of one or more of the specified/defined data or data types, the applicable content rule or rules are evaluated and the result applied to determine the characteristics of the content that is to be accessed and delivered to the customer.

These characteristics may include one or more of type, format, storage location (based on a URL, network address, or an identifier/label for a folder, category, event, or item), presentation location (based on a URL, network address, an identifier for content of a specific type and having an associated presentation location (such as an item ID, event name, season), etc.), the set of content that is to be presented and that is contained within a larger set of content (based on an identifier or tag), the presentation format or description (based on reference to a template, style sheet, web-page definition, outline, etc.), etc. In one embodiment, a process controlling the selection and presentation of content elements may submit a query, access a data store, receive and interpret a “published” stream of data, or use other means to obtain information it needs to evaluate one or more rules or conditions.

The content elements are accessible by the process at a location (data storage location, network location, etc.) associated with the user specified identifier, and may themselves be identified by that identifier. As an example, content elements to be used for a summer sale may be stored in a directory or file associated with the identifier “Sale: summer”. In another example, content elements may be identified by a “tag” that specifies a content element type (e.g., banner). In another example, such content elements may be identified by a “tag” that specifies a use case (e.g., Summer Sale) and a content element type (e.g., banner). In addition, the user may specify the arrangement or placement of the content elements with reference to a template or structure for a display, webpage, etc.

As described, in one embodiment, a rule may be of any suitable logical form, such as “If [certain parameters have specified values], then access all content elements from location X”, but “If parameter A has a value within a range of {a . . . b}, then access content element Y from location X1 ”. In the same or another embodiment, the rule may have the form of a “trigger” such that if a certain parameter (or group of parameters) have a value that exceeds a specified threshold, then certain content is accessed and presented (this might be used to offer a customer a special sale price based on inventory levels, the expected availability of a new model, trends in customer spending, etc.). In the same or another embodiment, the rule may depend on a rate of change of one or more parameters; for example, if inventory levels are changing at a certain rate, then one set of content is presented, but if the levels are changing at a different rate, then a different set of content is presented. In the same or another embodiment, a rule may depend on business related parameters (inventory) and real-time values of consumer behavior (browsing, rate of click-through, time spent viewing a specific product or page, conversion rate, etc.).

In general, a rule may depend on or be a function of one or more of customer specific attributes/data (customer type, device type, customer purchase history, customer browsing history, customer actual or inferred demographic data, etc.), retailer specific attributes/data (inventory level, profit margin, rate of change of inventory level, location of warehouse, location of store, etc.), and other relevant data (season, relationship to upcoming event, etc.). The flexibility in defining the data to be presented, the conditions under which to present it, and the placement of the data (such as the delivery format and arrangement) provided by embodiments of the inventive system and methods permits a retailer to deliver targeted content to a customer based on multiple and in some cases dynamic parameters. This enables the delivered content to be more relevant to the customer and more closely aligned with the retailer's business operations and interests.

In order to implement an embodiment of the invention, it may be helpful to define a data schema that can be used to represent some of the relations or data types used by the systems and processes that are part of the embodiment. Although not required, this may provide a more efficient way of organizing and processing data used to perform one or more of the processes or operations described herein.

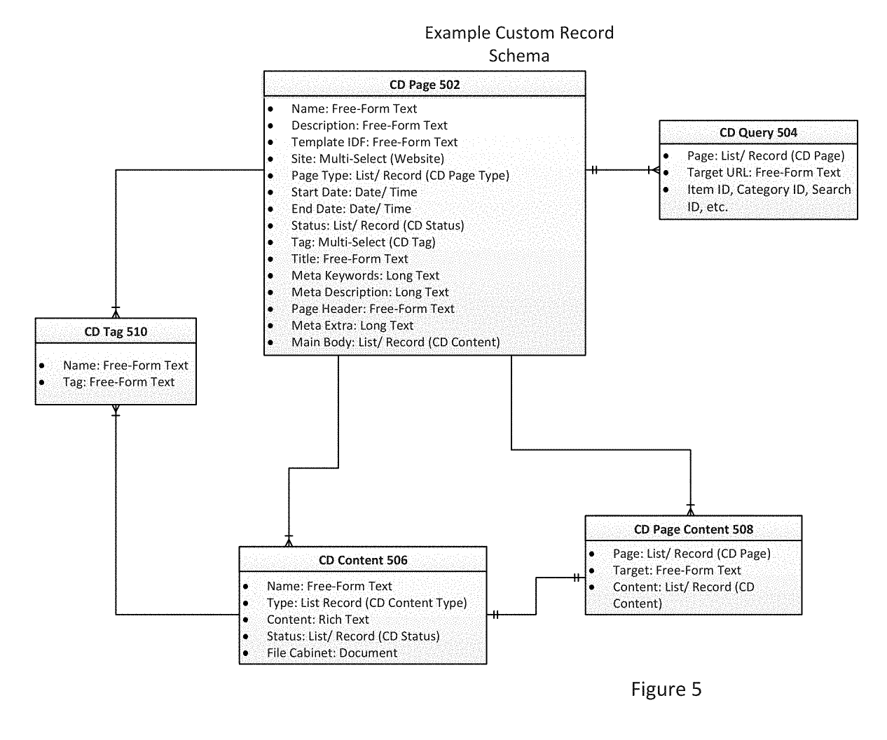

As an example, FIG. 5 is a diagram illustrating a data schema that may be used when implementing an embodiment of the invention. As shown in the figure, an example data schema that may be used as part of implementing an embodiment of the invention may include one or more of the following elements:
CD PAGE (element 502) represents the data which the business owner wants to have rendered in the actual HTML output. For example, the title and template which is used can be configured based on the device of the customer. One customer may see a different layout than other customers;
CD QUERY (element 504) represents the URL (e.g., site.com/mens) which the business owner wants to target (i.e., the location where the identified/selected/determined content should be presented; this may be specified by a URL, network reference, item ID, category ID, network address, event name, etc.). Many URLs may reference the same CD PAGE;
CD CONTENT (element 506) represents the actual HTML/Image which should be rendered when a rule is “true”. The HTML can be entered using a rich textbox or referenced from a file in a file-cabinet;
CD PAGE CONTENT (element 508) represents where the actual content should appear. Target can be an ID in the DOM or a CSS selector. The content (e.g., banner will be rendered in the specified target); and
CD TAG (element 510) represents each specific tag that the business owner can set on a PAGE. For example: browser:safari.

Embodiments of the inventive system and methods may be used to define and apply one or more rules or conditions that when satisfied, result in specific content being accessed and presented to a customer. The rules or conditions may be based on current or time averaged values of one or more business parameters (such as revenue, sales level, profit margin, inventory level, rate of change of inventory, relative sales at a specific store location, etc.) in combination with customer specific data (such as customer location, customer browsing behavior, customer transaction history, expected customer spend level, etc.). The content accessed and presented may be related to business advertising, promotional offerings, discounts, product information, business announcements, local activities, etc. In this way embodiments of the invention leverage the multiple types of business data available on a multi-tenant platform (and the associated business applications) to permit a business owner or operator to identify and provide targeted content to a customer or prospective customer in ways that conventional systems cannot. As noted, the ability to store, access, and process a variety of business related data within one platform or “suite” of applications enables embodiments of the invention to provide users with greater flexibility in defining the parameters of a customized content delivery process for customers.

For example, a business owner can use an embodiment of the invention to implement one or more of the following example scenarios or “campaigns”:
Retailer ABC has multiple stores across the country. These stores have local events to encourage community involvement as well as to promote brand awareness. The retailer would like shoppers who visit their website from these local areas to be able to read about these local events, and may be even sign up to participate. Hence this retailer has multiple local event content blogs and banners that they want to use as target content based on a geo-location attribute of the shopper/customer.
To provide this service, they can use an embodiment of the invention to create a new tag-“zipcode”. They can then enter values for this tag, such as when zipcode: 95051 and when zipcode: 94103, etc. They then tag different content with these tag values (note that they can attach multiple tag values to one content rule—in this example case they could have one blog that is tagged by multiple zip codes). When the front-end application determines the zipcode of the shopper, that information is sent to the content application which is then able to search for content that is tagged by that zipcode value and return that content to the front end application for display to the shopper;
Retailer ABC might want to show a particular banner when shoppers are viewing their site using a specific device or class of devices (such as an IPad or IPhone, as opposed to a desktop computer). This may be of value because some content may display better on one or another device, and some content may be more relevant to a specific device or type of shopper (such as a shopper using a mobile device, etc.). In this example use case, the retailer could create a new “tag”-device. They can then enter values for the tag, such as device:mobile, device:iPad, etc. The retailer would then create different content rules for each device—with the rule(s) pointing to the different content banners. When a shopper visits the site, the front end client application determines the device type and passes the value of the device to the content delivery application, which then returns the appropriate banner for display to the shopper;
Retailer ABC wants to target “Recommendations”—these could be recommendations generated by other sources, by data mining of retailer data, by use of any suitable recommendation or collaborative filtering technique, machine learning model, etc. A recommendation could be associated with a suitable “tag” which serves to permit the invention to provide a recommendation to a shopper based on the shopper's location, purchase history, spending habits, demographics, etc.;
For the segment of customers who have purchased more than $x from a “seller/vendor/brand/category” in the last month, show them the new arrivals in that category when they come to the homepage;
For the segment of customers who are visiting the website from a location that is close proximity from a local store event, show them information about the event and how to sign up—like a book signing event, or a cooking class;
For a segment of customers who visit the website in the early morning hours when an early-bird sale is ON, show them information about the sale on the homepage;
For a segment of customers who have an item in the cart which is about to go out of stock—remind them to act fast as inventory is low; or
For a segment of customers who are “loyal advocates” based on some criteria, as specified on the customer record as a flag—give them access to early sale or special promotion codes.

As described, in some embodiments, a front-end application such as a website, shopping application, point of sale (POS) terminal application, etc. may be used to determine the value(s) of one or more specified attributes that are relevant to determining the storage location and/or specific content to be delivered to a customer (as described with reference to the step or stage 420 of FIG. 4). Further, the attribute values may be used to evaluate one or more applicable rules, criteria, or conditions that determine the content to present and/or how to present that content. Since the operation of the front-end application is customizable, tenant-users can select targeted content based on any attribute or combination of attributes (as subject to any desired rules, criteria, conditions, etc.) that they consider relevant. This information is then passed to a second process which locates the appropriate content (such as content that is tagged for that attribute) and returns the appropriate content to the front end application for display to the retailer and/or the customer.

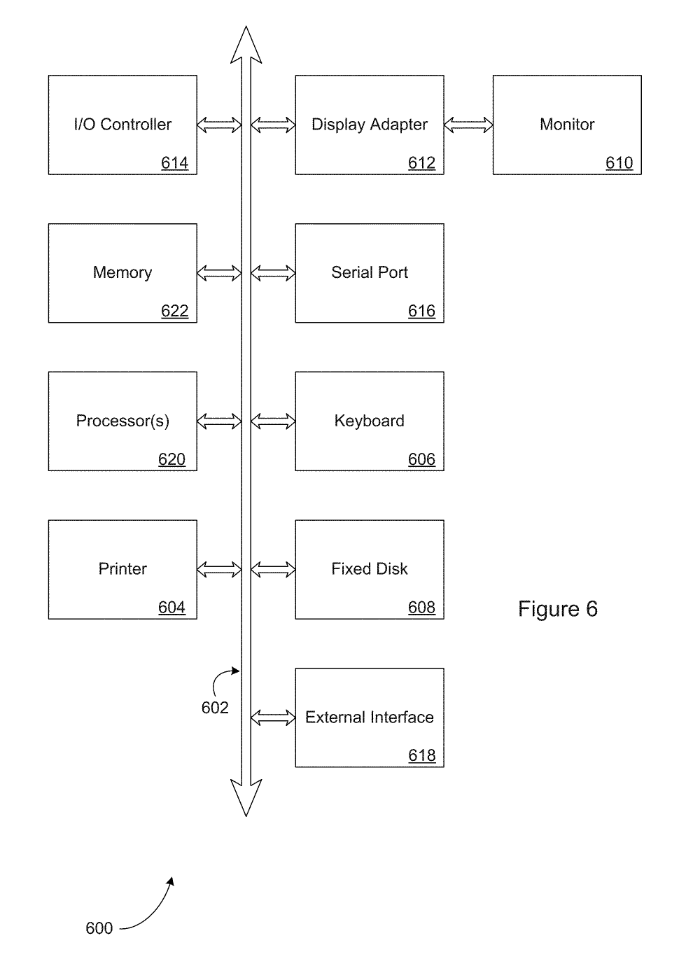

In accordance with one embodiment of the invention, the system, apparatus, methods, processes, functions, and/or operations for enabling efficient configuration and presentation of a user interface to a user based on the user's previous behavior may be wholly or partially implemented in the form of a set of instructions executed by one or more programmed computer processors such as a central processing unit (CPU) or microprocessor. Such processors may be incorporated in an apparatus, server, client or other computing or data processing device operated by, or in communication with, other components of the system. As an example, FIG. 6 is a diagram illustrating elements or components that may be present in a computer device or system 600 configured to implement a method, process, function, or operation in accordance with an embodiment of the invention. The subsystems shown in FIG. 6 are interconnected via a system bus 602. Additional subsystems include a printer 604, a keyboard 606, a fixed disk 608, and a monitor 610, which is coupled to a display adapter 612. Peripherals and input/output (I/O) devices, which couple to an I/O controller 614, can be connected to the computer system by any number of means known in the art, such as a serial port 616. For example, the serial port 616 or an external interface 618 can be utilized to connect the computer device 600 to further devices and/or systems not shown in FIG. 6 including a wide area network such as the Internet, a mouse input device, and/or a scanner. The interconnection via the system bus 602 allows one or more processors 620 to communicate with each subsystem and to control the execution of instructions that may be stored in a system memory 622 and/or the fixed disk 608, as well as the exchange of information between subsystems. The system memory 622 and/or the fixed disk 608 may embody a tangible computer-readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, Javascript, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

What is claimed is:

1. A multi-tenant data processing system, comprising:
one or more business related data processing applications installed in the system and accessible by a plurality of tenants of the multi-tenant data processing system;
a data storage element coupled to the one or more business related data processing applications;
a processor programmed with a set of instructions, wherein when executed by the processor the instructions cause the system to
generate a user interface for a tenant user;
receive a selection of an identifier from the tenant user for a process to select and present content to a customer;
receive a description of a rule or condition from the tenant user, wherein the rule or condition specifies one or more aspects of content to be accessed and presented to the customer upon satisfaction of the rule or condition;
determine a value or values of one or more data associated with the tenant user and/or the customer, wherein the data associated with the tenant user is contained in the data storage element;
evaluate the rule or condition based at least in part on the determined data value or values;
if the rule or condition is satisfied, then initiate a process to access the specified content for presentation to the customer; and
present the accessed element or elements of content to the customer.

2. The multi-tenant data processing system of claim 1, wherein the business related data processing applications installed in the system include one or more of an enterprise resource planning (ERP), a customer relationship management (CRM), or an eCommerce application.

3. The multi-tenant data processing system of claim 1, wherein the identifier is an attribute of the tenant user or of the customer.

4. The multi-tenant data processing system of claim 3, wherein the attribute is one or more of a characteristic of the customer, a characteristic of the tenant user's business, or a characteristic of the time or date.

5. The multi-tenant data processing system of claim 1, wherein the received rule or condition is a function of one or more of a characteristic of the customer, a characteristic of the customer's device, the customer's location, the day, the time, or a characteristic of the tenant user's business operations.

6. The multi-tenant data processing system of claim 5, wherein the characteristic of the customer includes one or more of age, age range, gender, inferred or actual income, expected spend amount, or level of education, the characteristic of the customer's device includes one or more of type of device or a capability of the device, the customer's location includes one or more of the customer's present location, expected location, or previous location, and the characteristic of the tenant user's business operations includes one or more of a sales level, revenue over a defined time period, profit margin, inventory level, or a rate of change of one or more of those characteristics.

7. The multi-tenant data processing system of claim 1, wherein determining the value or values of one or more data associated with the tenant user further comprises accessing data associated with the tenant user's account that is stored as part of operating the multi-tenant data processing system.

8. The multi-tenant data processing system of claim 7, wherein the data associated with the tenant user's account is one or more of an input to, or the result of a data processing operation performed by one or more of the business related data processing applications installed in the system.

9. The multi-tenant data processing system of claim 1, wherein determining the value or values of one or more data associated with the tenant user and/or the customer further comprises:
determining one or more of a characteristic of the customer, a characteristic of the customer's device, the customer's location, or the customer's relative location; and
using the determined characteristic or information to determine the process to select and present content to the customer.

10. The multi-tenant data processing system of claim 1, wherein the tenant user provides one or more of a desired destination for the presented content, a location of one or more content elements, and a desired arrangement for presenting one or more content elements to the customer by means of inputs to the user interface.

11. A method for presenting content to a customer, comprising:
generating a user interface for a user;
receiving a selection of an identifier from the user for a process to select and present content to the customer;
receiving a description of a rule or condition from the user, wherein the rule or condition specifies one or more aspects of content to be accessed and presented to the customer upon satisfaction of the rule or condition;
determining a value or values of one or more data associated with the user and/or the customer, wherein the data associated with the user is related to the user's business operations;
evaluating the rule or condition based at least in part on the determined data value or values;
if the rule or condition is satisfied, then initiating a process to access the specified content for presentation to the customer; and
presenting the accessed element or elements of content to the tenant customer.

12. The method of claim 11, wherein the data associated with the user that is related to the user's business operations is one or more of financial, enterprise resource planning (ERP), customer relationship management (CRM) or eCommerce related data.

13. The method of claim 11, wherein the identifier is an attribute of the user or of the customer.

14. The method of claim 13, wherein the attribute is one or more of a characteristic of the customer, a characteristic of the user's business, or a characteristic of the time or date.

15. The method of claim 11, wherein the received rule or condition is a function of one or more of a characteristic of the customer, a characteristic of the customer's device, the customer's location, the day, the time, or a characteristic of the user's business operations.

16. The method of claim 15, wherein the characteristic of the customer includes one or more of age, age range, gender, inferred or actual income, expected spend amount, or level of education, the characteristic of the customer's device includes one or more of type of device or a capability of the device, the customer's location includes one or more of the customer's present location, expected location, or previous location, and the characteristic of the user's business operations includes one or more of a sales level, revenue over a defined time period, profit margin, inventory level, or a rate of change of one or more of those characteristics.

17. The method of claim 11, wherein determining the value or values of one or more data associated with the user further comprises accessing data associated with the user's account that is stored as part of operating a multi-tenant data processing system.

18. The method of claim 17, wherein the data associated with the user's account is one or more of an input to, or the result of a data processing operation performed by a business related data processing application installed as part of the multi-tenant data processing system.

19. The method of claim 11, wherein determining the value or values of one or more data associated with the user and/or the customer further comprises:
determining one or more of a characteristic of the customer, a characteristic of the customer's device, the customer's location, or the customer's relative location; and
using the determined characteristic or information to determine the process to select and present content to the customer.

20. The method of claim 11, wherein the user provides one or more of a desired destination for the presented content, a location of one or more content elements, and a desired arrangement for presenting one or more content elements to the customer by means of inputs to the user interface.
